(19) United States
(12) Patent Application Publication
(10) Pub. No.: US 2018/0084754 A1
(43) Pub. Date: Mar. 29, 2018

(54) HABITAT CONTAINER SYSTEM

(71) Applicant: HONEST STAR ENTERPRISES LIMITED, Kwai Chung (HK)

(72) Inventors: Kazutoshi TOMINAGA, Osaka (JP); Hikaru NAKAGAWA, Osaka (JP)

(73) Assignee: HONEST STAR ENTERPRISES LIMITED, Kwai Chung (HK)

(21) Appl. No.: 15/626,781

(22) Filed: Jun. 19, 2017

(30) Foreign Application Priority Data
Sep. 23, 2016 (JP) 2016-185536

(51) Int. Cl. A01K 1/03

(52) U.S. Cl. CPC A01K 1/031; A01K 1/03

(57) ABSTRACT

A habitat container system P1 includes at least one habitat container 5 and a holder 1 having plural container installation spaces 13 arranged vertically. The holder 1 includes a pair of front and rear frames 11 arranged via the container installation spaces 13, a lateral opening 15 opening the container installation space 13 laterally, a vertical opening 14 communicating container installation spaces 13 arranged vertically adjacent, and a pair of front and rear support portions 2 provided on opposing sides of the pair of front and rear frames 11. The habitat container 5 includes a pair of outward protrusions 65. In a state in which the habitat container 5 is accommodated in the container installation space 13, the habitat container 5 is supported by the holder 1 with the outward protrusions 65 arranged on the support portions 2.

### CROSS-REFERENCE TO THE RELATED APPLICATIONS

The present application claims priority to Japanese Patent Application No. 2016-185536 filed on Sep. 23, 2016, the entire disclosure of which is incorporated herein by reference in its entirety.

### BACKGROUND OF THE INVENTION

### Field of the Invention

The present invention relates to a habitat container system in which habitat containers for use in, e.g., breeding or cultivating relatively small creatures, such as, e.g., small animals and plants, are arranged and displayed.

The following description of related art sets forth the inventor's knowledge of related art and certain problems therein and should not be construed as an admission of knowledge in the prior art.

For example, when keeping and observing small animals, such as, e.g., insects, reptiles, amphibians, and fish, an animal breeding container is generally used. In recent years, when keeping a number of small animals, in some cases, the small animals are kept and bred in animal breeding containers by keeping one animal in one container or plural animals in one container. With such a breeding method, when the number of breeding containers increases, it becomes difficult to secure the space for arranging the breeding containers.

Under the circumstances, as shown in the following Patent Documents 1 to 3, a breeding container storage device that manages a plurality of breeding containers using a storage rack is disclosed. In the breeding container storage device disclosed in Patent Document 1, a plurality of breeding containers are stored by arranging breeding containers on shelf plates of the storage rack.

In the breeding container storage device disclosed in Patent Documents 2 and 3, it is configured such that a plurality of breeding containers are stored by hanging each of a plurality of breeding containers between shelf plates via rails (Patent Document 1: Japanese Unexamined Patent Application Publication No. 2005-95004, Publication No. 2: Japanese Unexamined Patent Application No. 2015-84703, Patent Document 3: Japanese Utility Model Registration No. 3187230).

However, in the conventional breeding container storage devices described in the aforementioned Patent Documents 1 to 3, since the stored breeding containers are arranged between the shelf plates of the storage rack, depending on the viewing angle, the shelf plate blocks the field of vision. For this reason, there was a problem that it was impossible to sufficiently see or observe the small animals, etc., kept in the breeding containers.

The description herein of advantages and disadvantages of various features, embodiments, methods, and apparatus disclosed in other publications is in no way intended to limit the present invention. For example, certain features of the preferred described embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The disclosed embodiments of this disclosure have been developed in view of the aforementioned and/or other problems in the related art. The disclosed embodiments of this disclosure can significantly improve upon existing methods and/or apparatuses.

The present invention was made in view of the aforementioned problems, and aims to provide a habitat container system capable of adequately observing animals, plants, etc., kept in a habitat container.

The other purposes and advantages of some embodiments of the present invention will be made apparent from the following preferred embodiments.

In order to attain the aforementioned objects, some embodiments of the present invention have the following structure.

[1] According to a first aspect of the present invention, a habitat container system includes at least one habitat container made of plastic, and a holder provided with plural container installation spaces each capable of accommodating the habitat container, the plural installation spaces being arranged vertically. The holder includes a pair of front and rear frames arranged forward and rearward of the container installation space, a lateral opening that laterally opens the container installation space, a vertical opening that communicates the container installation space arranged vertically adjacent, and a pair of front and rear support portions provided on opposing sides of the pair of front and rear frames in each container installation space. The habitat container includes a pair of outward protrusions outwardly protruded from front and rear sides of the habitat container. The habitat container is capable of being freely taken in and out of the container installation space via the lateral opening. In a state in which the habitat container is accommodated in the container installation space, the pair of outward protrusions of the habitat container are arranged on the pair of front and rear support portions of the holder and the habitat container is supported by the holder.

[2] In the habitat container system as recited in the aforementioned Item [1], it may be configured such that the pair of front and rear frames is provided with front and rear openings that open each container installation space in a front and rear direction.

[3] In the habitat container system as recited in the aforementioned Item [1] or [2], it may be configured such that the pair of front and rear support portions of the holder is configured by a pair of rails extending in a lateral direction. The at least one habitat container is plural habitat containers, and at least two of the plural habitat containers are arranged side by side in one of the plural container installation spaces in the lateral direction.

[4] In the habitat container system as recited in any one of the aforementioned Items [1] to [3], it may be configured as follows. The pair of outward protrusions of the habitat container is provided with one of a positioning convex portion and a positioning concave portion, and the pair of front and rear support portion of the holder is provided with the other of the positioning convex portion and the positioning concave portion. Further, the positioning convex portion is fitted in the positioning concave portion to thereby position the habitat container relative to the holder.

[5] In the habitat container system as recited in anyone of the aforementioned Items [1] to [4], it may be configured as follows. The habitat container includes a container body, the container body including a bottom wall, a peripheral wall provided at an outer peripheral edge portion of the bottom wall so as to extend upward, an upper end opening provided on an inner side of an upper end of the peripheral wall, and an opening edge portion outwardly protruded from an upper edge of the the peripheral wall along a circumferential direction. The pair of outward protrusions is configured by front and rear side portions of the opening edge portion.

[6] In the habitat container system as recited in any one of the aforementioned Items [1] to [5], it may be configured as follows. The habitat container includes a container body and a lid. The container body includes a bottom wall, a peripheral wall provided at an outer peripheral edge portion of the bottom wall so as to extend upward, an upper end opening provided on an inner side of an upper end of the peripheral wall, and an opening edge portion outwardly protruded from the upper edge of the a peripheral wall along a circumferential direction. The lid includes a pair of front and rear hooks formed at front and rear sides of the lid. The pair of front and rear hooks is elastically engaged with front and rear side portions of the opening edge portion, so that the lid is fixed to the container body in a state of closing the upper end opening of the container body. The pair of outward protrusions is configured by the front and rear side portions of the opening edge portion. The positioning convex portion is configured by a tip portion of the hook.

[7] In the habitat container system as recited in any one of the aforementioned Items [1] to [6], it may be configured such that the holder is configured to be divided between the plural container installation spaces arranged vertically adjacent.

[8] According to a second aspect of the present invention, a habitat container system includes a habitat container made of plastic, and a holder provided with a container installation space capable of accommodating the habitat container. The holder includes a pair of front and rear frames arranged forward and rearward of the container installation space, a lateral opening that opens the container installation space laterally, a vertical opening that opens the container installation space vertically, and a pair of front and rear support portions provided on opposing sides of the pair of front and rear frames. The habitat container is provided with a pair of outward protrusions formed at front and rear sides of the habitat container. The habitat container is capable of being freely taken in and out of the container installation space via the lateral opening. In a state in which the habitat container is accommodated in the container installation space, the pair of outward protrusions of the habitat container is arranged on the pair of front and rear support portions of the holder and the habitat container is supported by the holder.

[9] In the habitat container system as recited in the aforementioned Item [8], it may be configured such that the pair of front and rear frames is provided with front and rear openings that open the container installation space in the front and rear direction.

[10] In the habitat container system as recited in any one of the aforementioned Items [1] to [9], it may be configured such that one of a positioning convex portion and a positioning concave portion is formed at an upper end of the holder and the other of the positioning convex portion and the positioning concave portion is formed at a lower end of the holder.

[11] According to a third aspect of the present invention, a habitat container display structure includes a plurality of the habitat container systems as recited in the aforementioned Items [1] to [10], wherein the plurality of the habitat container systems is arranged in contact with each other.

[12] In the habitat container display structure as recited in the aforementioned Item [11], it maybe configured such that the plurality of the habitat container systems is stacked vertically.

[13] In the habitat container display structure as recited in the aforementioned Item [11], it maybe configured such that the plurality of the habitat container systems is arranged side by side horizontally.

According to the habitat container system of the invention [1], since the vertical opening that communicates the upper and lower adjacent container installation spaces is provided, there exists on no shelf board, etc., to place habitat containers. For this reason, no vision is obstructed by shelf boards, etc., which enables full observation of creatures, such as, e.g., animals and plants, kept in the habitat container.

According to the habitat container system according to the invention as recited in the aforementioned Item [2], the inside of the habitat container can be observed from the front and rear direction via the front and rear openings, which enables more assured observation of animals and plants, etc.

According to the habitat container system of the invention as recited in the aforementioned Item [3], since multiple habitat containers can be accommodated in one container installation space, the habitat containers can be efficiently arranged.

According to the habitat container system of the invention as recited in the aforementioned Item [4], since the positioning convex portion can be fitted in the positioning concave portion and the position of the habitat container relative to the support piece can be fixed, the habitat container can be held in a stable state by the holder.

According to the habitat container system of the invention as recited in the aforementioned Item [5], since the opening edge portion of the container body is used as the outward protrusion, the structure can be simplified and the cost can be reduced as compared with the case in which the opening edge portion and the outward protrusion are separately formed.

According to the habitat container system of the invention as recited in the aforementioned Item [6], since the bent portion of the hook is used as a positioning convex portion, as compared with a case in which a hook and a positioning convex portion are additionally formed, the structure can be simplified and the cost can be reduced.

According to the habitat container system of the invention as recited in the aforementioned Item [7], since the number of stages of the container installation space can be freely adjusted according to a breeding situation, etc., the versatility can be improved.

According to the habitat container system of the invention as recited in the aforementioned Item [8], since the upper face of the container installation space of the uppermost row is opened upward through the vertical opening, there is no partition wall, such as, e.g., a ceiling wall. For this reason, the visibility is not blocked by a top wall, a lower wall, etc., which enables full observation of animals, plants, etc., kept in the habitat container. Especially, when using the habitat container system in a multiple stacked manner, since there exists no partition corresponding to the shelf board, etc., the observation can be made easier.

According to the habitat container system of the invention as recited in the aforementioned Item [9], the inside of the habitat container can be observed in the front and rear direction via the front and rear openings, which enables more assured observation of animals and plants, etc.

According to the habitat container system of the invention as recited in the aforementioned Item [10], a plurality of habitat containers can be arranged more efficiently.

According to the habitat container display structure of the invention as recited in the aforementioned Items [11] to [13], a plurality of habitat containers can be arranged more efficiently.

### BRIEF DESCRIPTION OF THE DRAWINGS

Embodiments of the present invention are shown by way of example, and not limitation, in the accompanying figures.

FIG. 1 is a perspective view showing a habitat container system according to a first embodiment of the present invention.

FIG. 2 is an exploded perspective view showing the habitat container system of the first embodiment.

FIG. 3 is a front view showing the habitat container system of the first embodiment.

FIG. 4 is a side cross-sectional view showing the habitat container system of the first embodiment.

FIG. 5 is an exploded perspective view showing a habitat container applied to the habitat container system of the first embodiment.

FIG. 6 is an enlarged cross-sectional view showing a periphery of a hook in the habitat container system of the first embodiment.

FIG. 7 is an exploded perspective view showing an example of a habitat container display structure according to the present invention.

FIG. 8 is a perspective view showing another example of the habitat container display structure according to the present invention.

FIG. 9 is a front view showing a habitat container system according to a second embodiment of the present invention.

FIG. 10 is a side view showing the habitat container system of the second embodiment.

FIG. 11 is a perspective view for explaining a habitat container system according to a third embodiment of the present invention.

### EMBODIMENT FOR CARRYING OUT THE INVENTION

In the following paragraphs, some embodiments of the present invention will be described by way of example and not limitation. It should be understood based on this disclosure that various other modifications can be made by those in the art based on these illustrated embodiments.

### First Embodiment

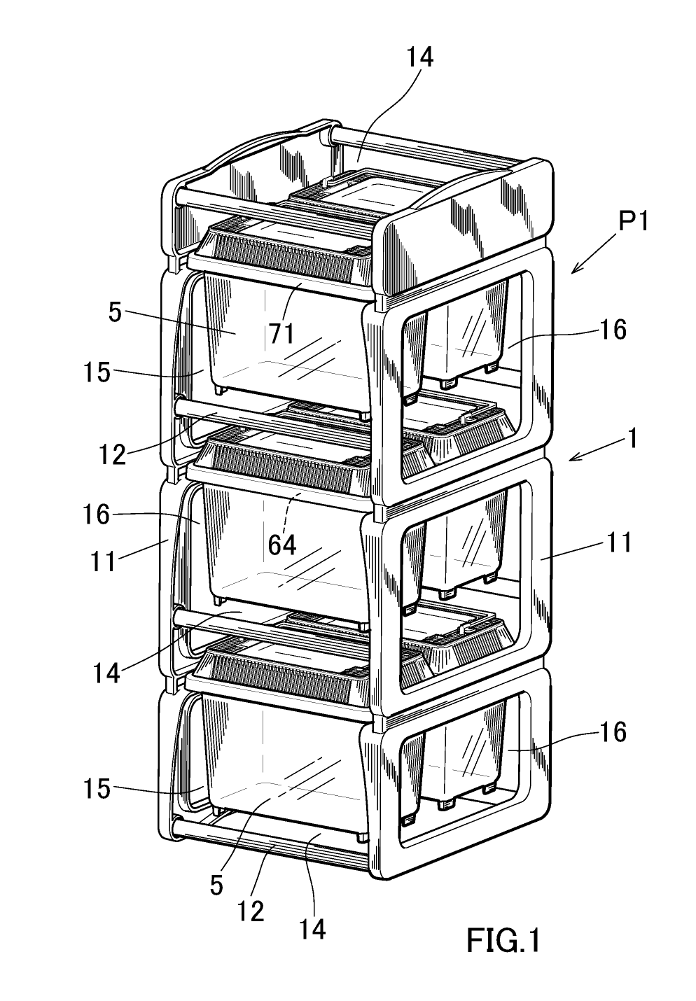

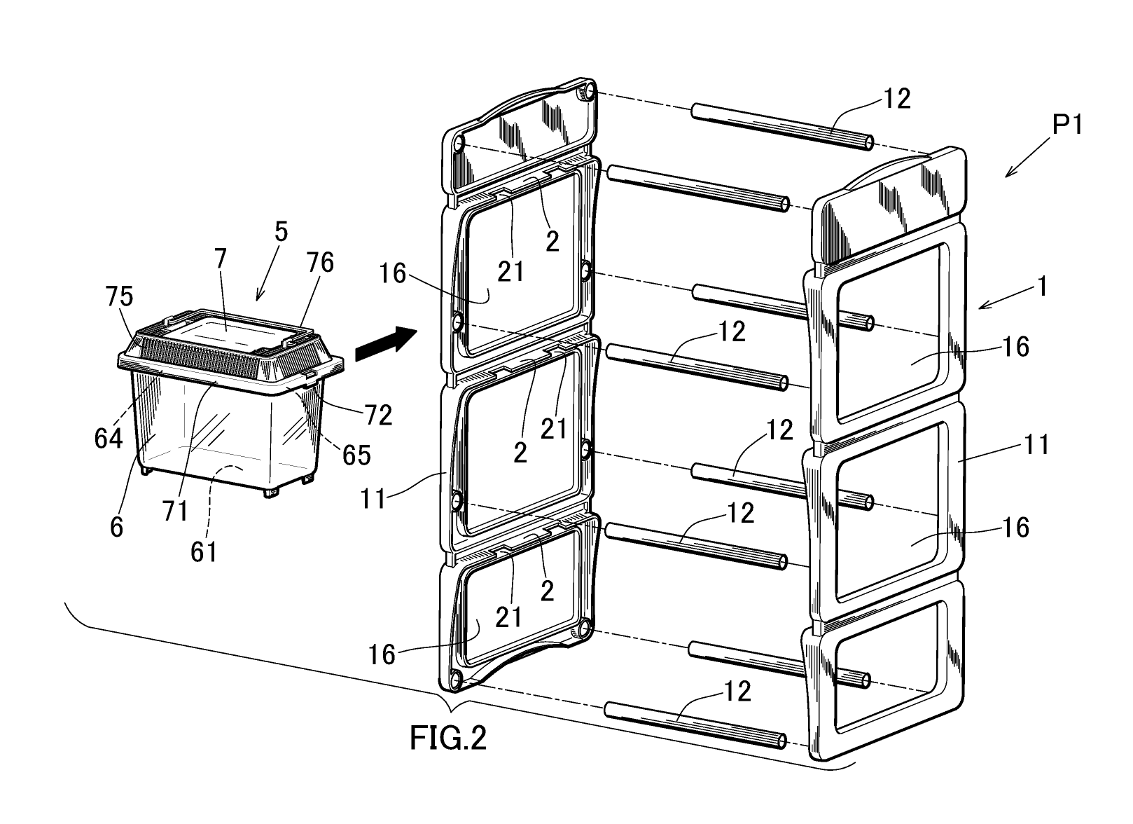

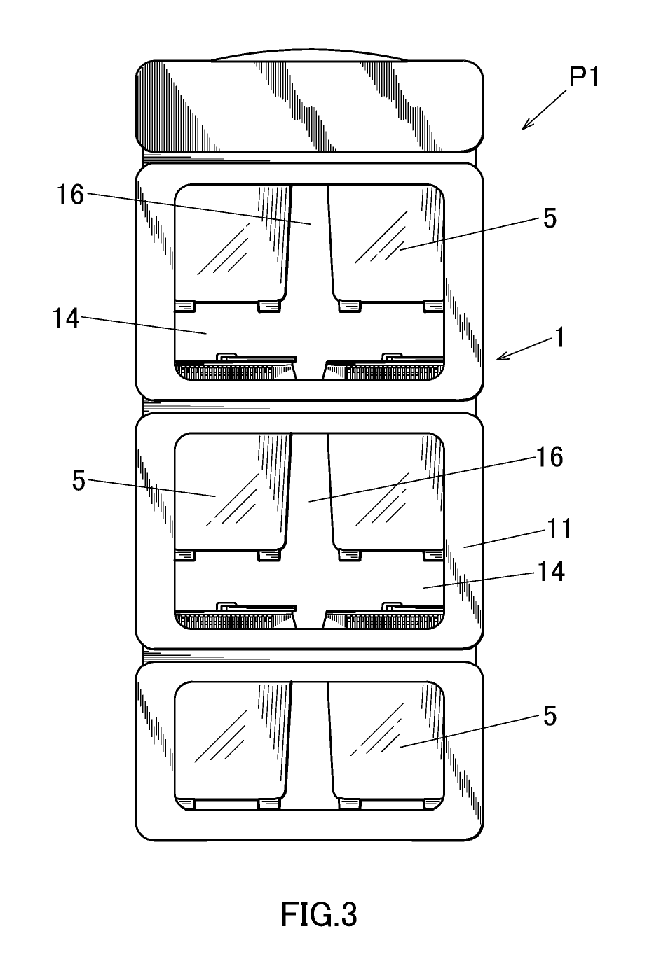

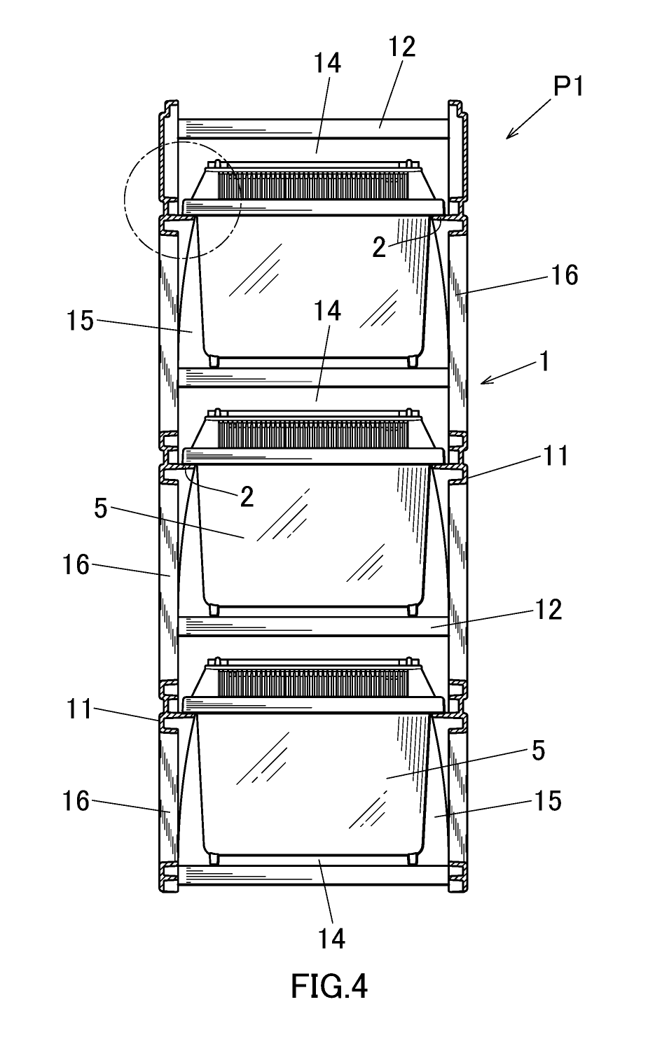

FIG. 1 is a perspective view showing a habitat container system P1 according to a first embodiment of the present invention, FIG. 2 is an exploded perspective view thereof, FIG. 3 is a front view thereof, and FIG. 4 is a side view thereof.

As shown in these figures, the habitat container system P1 of the first embodiment is provided with a holder 1 and a plurality of habitat containers 5 held by the holder 1. The habitat container system P1 of this embodiment has a front-back symmetrical shape, and when either one of sides in the front and rear direction is defined as a front side, the other is defined as a rear side. In the same manner, the habitat container system P1 of this embodiment has a laterally symmetrical shape, and when one of sides in the left and right direction is defined as a right side, the other is defined as a left side. Further, in this embodiment, in order to facilitate the understanding of the invention, the following description will be made by defining a direction perpendicular to the paper of FIG. 3 as a “front and rear direction”, a left and right direction in FIG. 3 as a “left and right direction” or “lateral direction”, an up and down direction in FIG. 3 as an “up and down direction” or “vertical direction”.

The holder 1 of the first embodiment is provided with a pair of front and rear frames 11 and 11 made of transparent plastic and arranged in parallel in a front and rear direction with a space therebetween. The pair of front and rear frames 11 and 11 are connected via a plurality of plastic connection pipes 12 as connecting frames. The connecting pipes 12 are arranged at both side edges of the pair of front and rear frames 11 and 11 with appropriate intervals in the up and down direction. A container installation spaces 13 are formed between the pair of front and rear frames 11 and 11. In this embodiment, a container installation space 13 is formed between adjacent connecting pipes 12 and 12 in the up and down direction, and three container installation spaces 13, 13, and 13 are arranged vertically or in the up and down direction.

Between the pair of front and rear frames 11 and 11, a space between the two left and right corresponding connecting pipes 12 and 12 is served as a vertical opening 14 opening in the up and down direction. By the vertical opening 14, almost the entire upper and lower faces of the container installation space 13 are opened upward and downward. In other words, the adjacent container installation spaces 13 and 13 communicate with each other by the vertical opening 14 arranged therebetween. Therefore, there is no partition wall, such as, e.g., a shelf plate that partitions between the vertically adjacent container installation spaces 13 and 13. Furthermore, since the upper face of the container installation space 13 of the uppermost row (the third row) is opened upward through the vertical opening 14, there is no partition wall, such as, e.g., a ceiling wall. Furthermore, since the lower face of the container installation space 13 of the lowest row (first row) is opened downward by the vertical opening 14, there is no partition wall, such as, e.g., a bottom wall.

Further, between the pair of front and rear frames 11 and 11, the space between the connecting pipes 12 and 12 arranged in the up and down direction is served as a lateral opening 15 which opens toward both sides. By this lateral opening 15, substantially the entire area of both side faces of each container installation space 13 is opened on both sides. In this embodiment, the habitat container 5 can be taken in and out of the container installation space 13 of the holder 1 through the lateral opening 15.

In the pair of front and rear frames 11 and 11, front and rear openings 16 and 16 opening in the front and rear direction are formed. The front and rear openings 16 and 16 are formed substantially corresponding to the front face and the rear face of each container installation space 13, respectively.

Therefore, in the holder 1 of this embodiment, each container installation space 13 is opened in six directions (omnidirections), i.e., in the up and down directions, the left and right directions, and the front and rear directions through the vertical openings 14, the left and right side openings 15, and the front and rear openings 16, respectively.

On the facing surfaces of the pair of front and rear frames 11 and 11, that is, on the inner sides of the pair of front and rear frames 11 and 11, a pair of front and rear rails 2 and 2 projecting inward and extending laterally or in the left and right direction are integrally formed corresponding to the upper part of each container installation space 13. In this embodiment, support portions are configured by the rails 2 and 2.

Two cutout portions 21 are formed in each of the rails 2 and 2. By this cutout portion 21, the habitat container 5 can be positioned with respect to the rail 2 as described later. In this embodiment, the cutout portion 21 is served as a positioning concave portion according to the present invention.

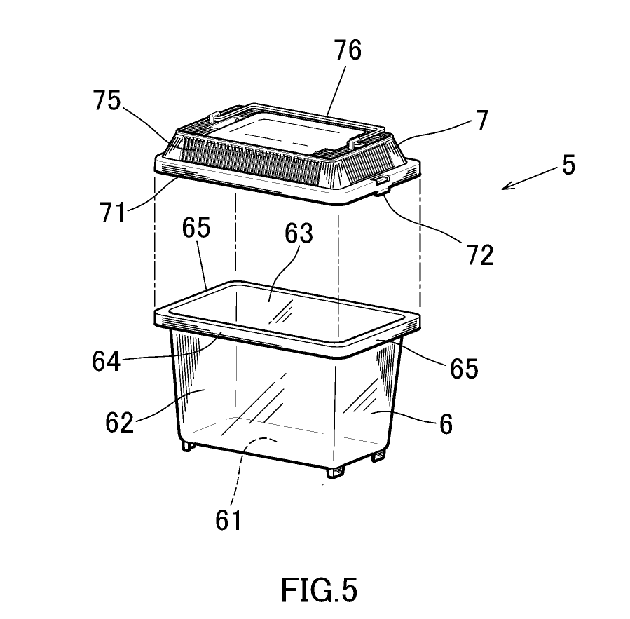

FIG. 5 is an exploded perspective view showing the habitat container 5. As shown in FIG. 1 to FIG. 5, the habitat container 5 includes a transparent plastic container body 6 and a plastic lid 7.

The container body 6 has a box-like shape with its upper end opened. That is, the container body 6 is integrally provided with a bottom wall 61 having a rectangular shape in plan view and a peripheral wall 62 of a rising shape formed at the outer peripheral edge portion of the bottom wall 61, and is formed into a substantially rectangular parallelepiped shape. On the inner side of the upper end of the peripheral wall 62 of the container body 6, there is provided an upper end opening 63 which opens the inside of the container body 6 upward. Furthermore, at the upper edge of the peripheral wall 62 of the container body 6, an opening edge portion 64 is integrally formed so as to protrude outward along the entire circumference of the peripheral wall 62.

In the first embodiment, the front and rear side portions 65 and 65 of the opening edge portion 64 are configured to serve as a pair of outward protrusions.

At the outer peripheral edge portion of the lid 7 to be arranged to close the upper end opening 63 of the container body 6, an outer peripheral wall 71 is formed so as to cover the opening edge portion 64 of the container body 6 from the outside. Further, at the center of each of the front and rear side portions of the outer peripheral wall 71, an elastic hook 72 is formed so as to protrude downward.

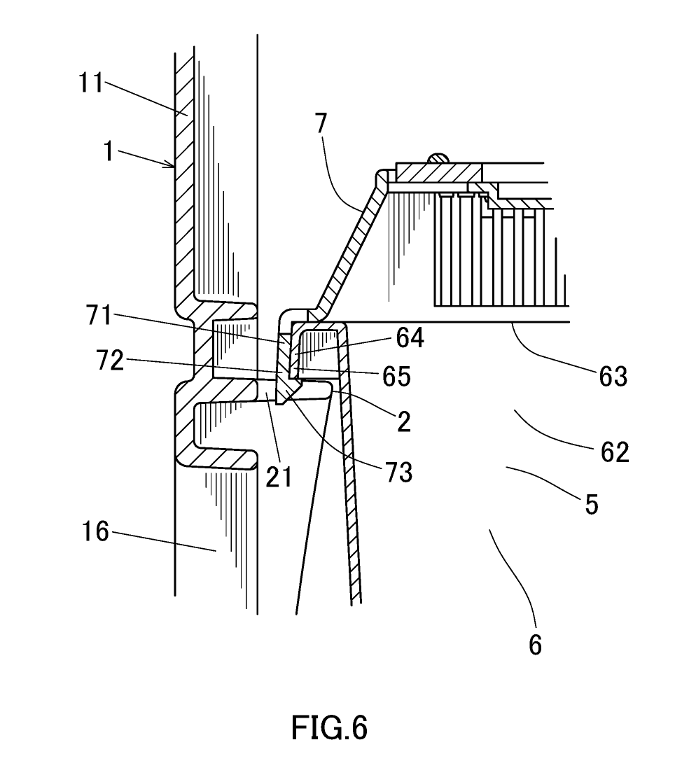

FIG. 6 is an enlarged cross-sectional view showing the periphery of the hook 72 of the habitat container system P1, which is a cross-sectional view showing a portion surrounded by a chain line in FIG. 4. As shown in the figure, a bent portion 73 is provided at the tip end of the hook 72 so as to bend inward. This bent portion 73 elastically engages with the lower end of the front and rear side portions 65 of the opening edge portion 64 of the container body 6, so that the lid 7 is attached to the container body 6 with the upper end opening 63 of the container body 6 closed.

When removing the lid 7 from the container body 6, the hook 72 is elastically deformed outward to release the bent portion 73 from the opening edge portion 64. This releases the engagement of the hook 72 with the opening edge portion 64, so that the lid 7 can be removed from the container body 6. To attach the lid 7 to the container body 6, the lid 7 is pushed toward the container body 6 in a state in which the lid 7 covers the upper end of the container body 6. With this, the hook 72 is deformed outward, and then returns inward by the elastic force, so that the bent portion 73 is engaged with the lower end of the opening edge portion 64. As a result, the lid 7 is attached to the container body 6 in a state in which the upper end portion of the container body 6 is covered by the lid 7.

As shown in FIG. 6, in this embodiment, in a state in which the lid 7 is attached to the container body 6, the bent portion 73 as the lower end portion of the hook 72 protrudes downward from the lower face of the opening edge portion 64. As will be described later, it is configured such that the habitat container 5 is positioned with respect to the rail 2 by the bent portion 73 of the hook 72. In this embodiment, by the bent portion 73, the tip end and the positioning convex portion of the hook 72 is configured.

Further, a handle 76 is provided on the upper surface of the lid 7 of the habitat container 5. This handle 76 is configured to be raised by the rotating operation. Thus, in a state in which the handle 76 is raised, the habitat container 5 can be carried by holding the handle 76 with hand.

As shown in FIGS. 1 to 4, when accommodating the habitat container 5 having the aforementioned configuration in a predetermined container installation space 13 of the holder 1, the habitat container 5 is accommodated from the lateral opening 15 of the predetermined container installation space 13. At this time, while sliding the front and rear side portions 65 and 65 of the opening edge portion 64 of the habitat container 5 along the pair of front and rear rails 2 and 2 provided at a predetermined container installation space 13, the habitat container 5 is taken in a predetermined container installation space 5. Then, the bent portions 73 and 73 of the front and rear hooks 72 and 72 are fitted in the predetermined cutout portions 21 and 21 of the pair of rails 2 and 2 to thereby simultaneously prevent inadvertent misalignment of the habitat container 5 with respect to the pair of rails 2 and 2 and position the habitat container 5. With the habitat container 5 thus positioned, the front and rear side portions 65 and 65 of the opening edge portion 64 of the habitat container 5 are supported by a pair of front and rear rails 2 and 2 of the holder 1. As a result, the habitat container 5 is retained in a state of being held by the holder 1. As described above, by simply inserting the habitat container 5 from the lateral opening 15 of the holder 1 and fitting the hooks 72 in the cutout portions 21 of the rails 2, the habitat container 5 can be attached to the holder 1.

In the holder 1 of the first embodiment, three container installation spaces 13 are formed in the up and down directions, and two habitat containers 5 can be accommodated and held in each container installation space 13 as described above. Thus, a total of six habitat containers 5 can be arranged vertically in a side by side manner.

On the other hand, in the case of taking out the habitat container 5 from the holder 1, the habitat container 5 is slightly lifted upward to pull the bent portions 73 and 73 of the hooks 72 and 72 out of the cutout portions 21 and 21 of the pair of rails 2 and 2. With this, the locking of the habitat container 5 to the rails 2 and 2 is released. Therefore, the habitat container 5 can be taken out of the holder 1 by moving laterally through the lateral opening 15 of the container installation space 13. In this way, by merely pulling the hook 72 out of the cutout portion 21 of the rail 2 and moving the habitat container 5 laterally, the habitat container 5 can be taken out of the holder 1.

As described above, according to the habitat container system P1 of the first embodiment, the habitat container 5 is suspended by the rails 2 and 2 of the holder 1 and held in the container installation space 13, and further almost the entire area of the adjacent container installation spaces 13 and 13 is communicated by the opening 14. Thus, no shelf board, etc., for arranging the habitat container 5 exists. For this reason, the visibility is not blocked by such a shelf board, which enables full observation of animals, plants, etc., kept in the habitat container 5.

Particularly in the first embodiment, the container installation space 13 is opened in all directions, i.e., in the up and down direction, the left and right direction, and the front and rear direction by the vertical openings 14, the left and right openings 15, and the front and rear openings 16, respectively. As a result, the habitat container 5 in the container installation space 13 can be observed from all directions more assuredly.

Further, in the habitat container system P1 of the first embodiment, since there is no shelf boards, the material cost can be suppressed correspondingly, and therefore the cost can be reduced and further the space for installing shelf boards can be omitted. Therefore, it is possible to reduce the size of the entire holder.

Further, since there is no shelf boards, no cleaning work for removing dust and dirt accumulated on shelf boards and therefore maintenance can be easily performed.

According to the habitat container system P1 of the first embodiment, the front and rear side portions 65 and 65 of the opening edge portion 64 of the habitat container 5 are supported by the front and rear rails 2 and 2 of the holder 1. Therefore, the habitat container 5 can be held in a stable state with two-point support, and the habitat container 5 can be reliably prevented from misalignment or detachment.

Further, in the first embodiment, the position of the habitat container 5 with respect to the rails 2 and 2 is fixed by fitting the tip end of the hooks 72 and 72 of the habitat container 5 in the positioning cutout portions 21 and 21 formed in the rails 2 and 2 of the holder 1. Therefore, the habitat container 5 can be held with respect to the holder 1 in a more stable state, which can more reliably prevent shifting and/or detachment of the habitat container 5.

In the first embodiment, the front and rear side portions 65 and 65 of the opening edge portion 64 of the container body 6 are used as outward protrusions. Therefore, compared to the case in which the opening edge portion 64 and outward protrusions are additionally formed, it is possible to simplify the structure and reduce the cost due to the simplification of the structure.

Furthermore, in this embodiment, since the bent portion 73 of the hook 72 is used as a positioning convex portion, as compared with the case in which the hook 72 and a positioning convex portion are additionally formed, the structure can be simplified and the cost can be reduced.

In the first embodiment, the habitat container 5 can be held in the holder 1 by simply accommodating the habitat container 5 from the lateral opening 15 of the holder 1 and hanging on the rails 2. Further, the habitat container 5 can be taken out of the holder 1 by simply pulling out the habitat container 5 hanged on the rails 2 from the lateral opening 15.

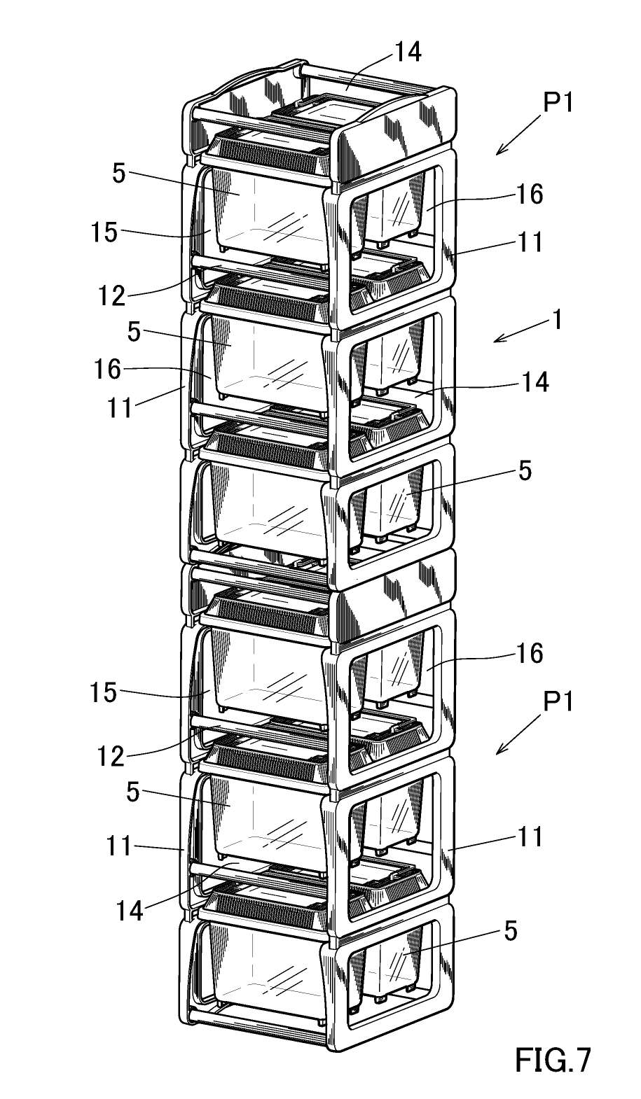

FIG. 7 is a perspective view showing an example of a habitat container display structure using the habitat container system P1 of the first embodiment. As shown in the figure, in this habitat container display structure, two habitat container systems P1 and P1 of the first embodiment are stacked one on top of the other and detachably fixed to each other by a well-known positioning member. As a well-known positioning member, a positioning member, etc., employed in a habitat container system P3 of a third embodiment, which will be described later, may be used.

In this habitat container display structure, the case in which two habitat container systems P1 are stacked was described as an example. However, the present invention is not limited to this, but the present invention allows to stack three or more habitat container systems.

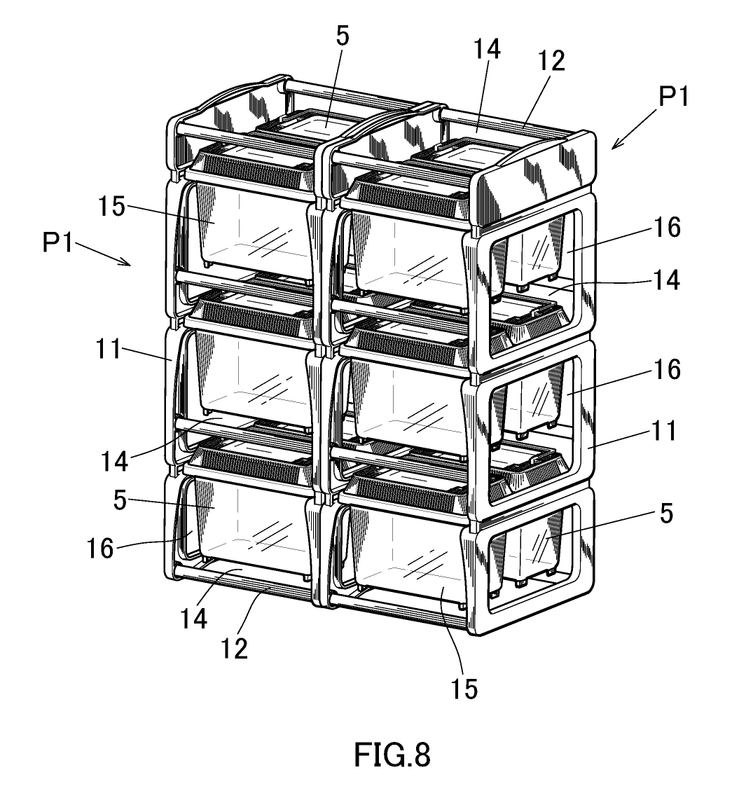

FIG. 8 is a perspective view showing a habitat container display structure of another example using the habitat container systems P1 of the first embodiment. As shown in the figure, in this habitat container display structure, two habitat container systems P1 and P1 of the first embodiment are arranged on behind the other, and are detachably connected to each other by a well-known connection method. Here, as a well-known connection method, it is possible to use a connection method using a hook, a connection method using male and female fittings, a connection method using a band, and the like.

In this habitat container display structure, the case in which two habitat container systems P1 are arranged one behind the other is described as an example. However, the present invention is not limited thereto. In the present invention, the habitat container systems may be arranged side by side.

Alternatively, three or more of them may be arranged side by side in the front and rear direction and in the right and left direction.

It goes without saying that the structure of FIG. 7 and the structure of FIG. 8 may be used in combination. In other words, the habitat container systems P1 may be arranged one behind the other, or left and right, and further stacked one on top of the other in multiple stages.

### Second Embodiment

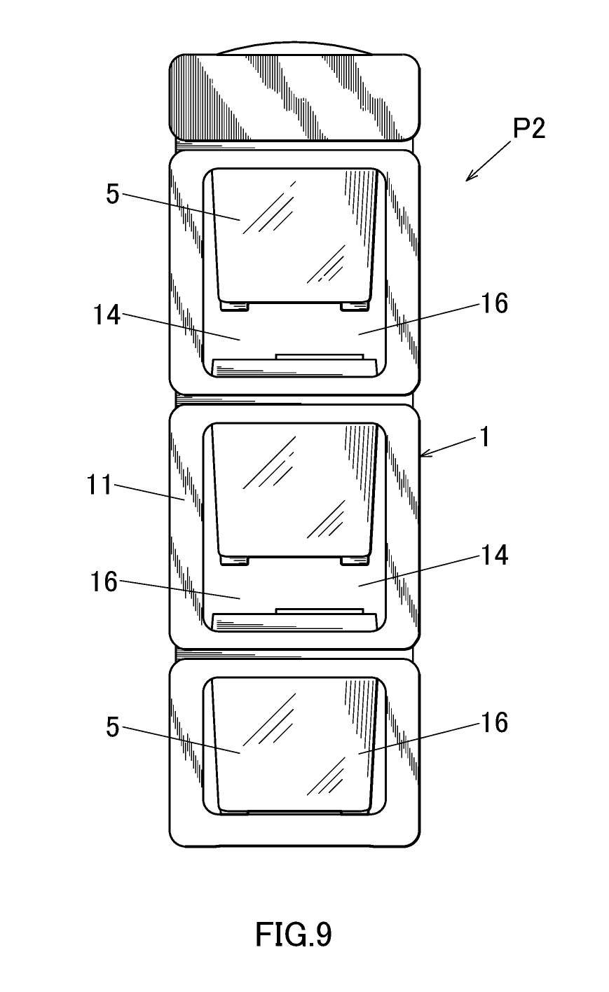

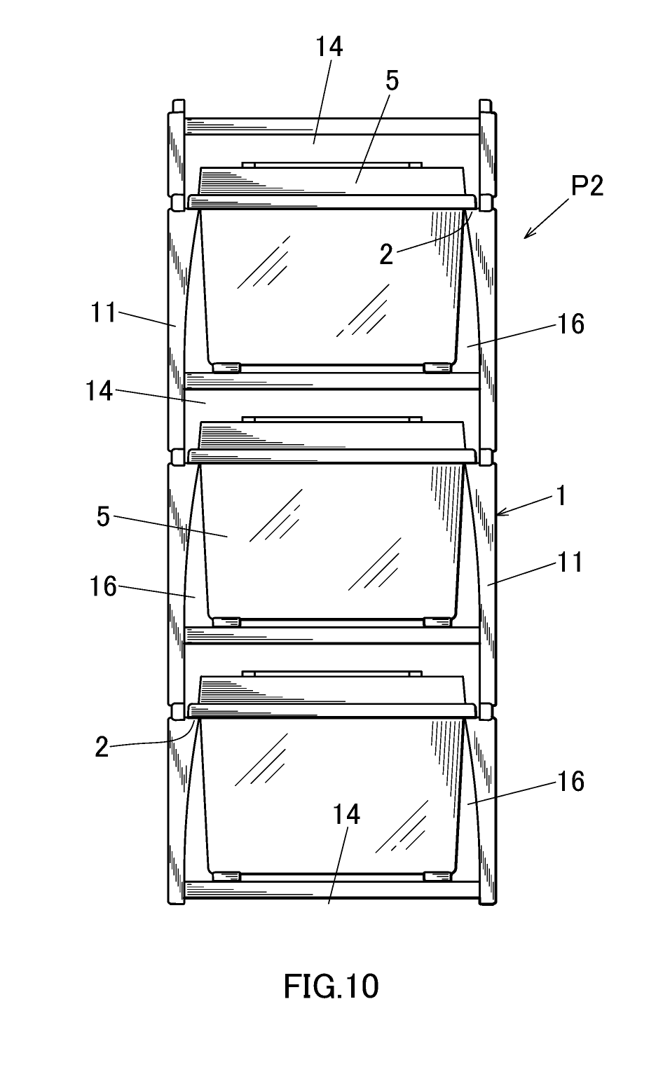

FIGS. 9 and 10 are a front view and aside view showing a habitat container system P2 according to a second embodiment of the present invention. As shown in the figures, the habitat container system P2 differs from the habitat container system P1 of the first embodiment in that the habitat container system P1 of the first embodiment is configured to hold two container installation spaces 13, while the habitat container 5 of the second embodiment is configured to hold one habitat container in one container installation space 13.

In this habitat container system P2 of the second embodiment, since the other configurations are substantially the same as those of the habitat container system P1 of the first embodiment, the identical or corresponding parts are denoted by the same reference numerals, and the redundant description is omitted.

Also in the habitat container system P2 of the second embodiment, in the same manner as in the first embodiment, the same effects can be obtained.

Also in the habitat container system P2 of the second embodiment, in the same manner as the structures of FIGS. 7 and 8, a plurality of them may be stacked one on top of the other, or a plurality of them may be arranged side by side in the front and rear direction and in the left and right direction.

### Third Embodiment

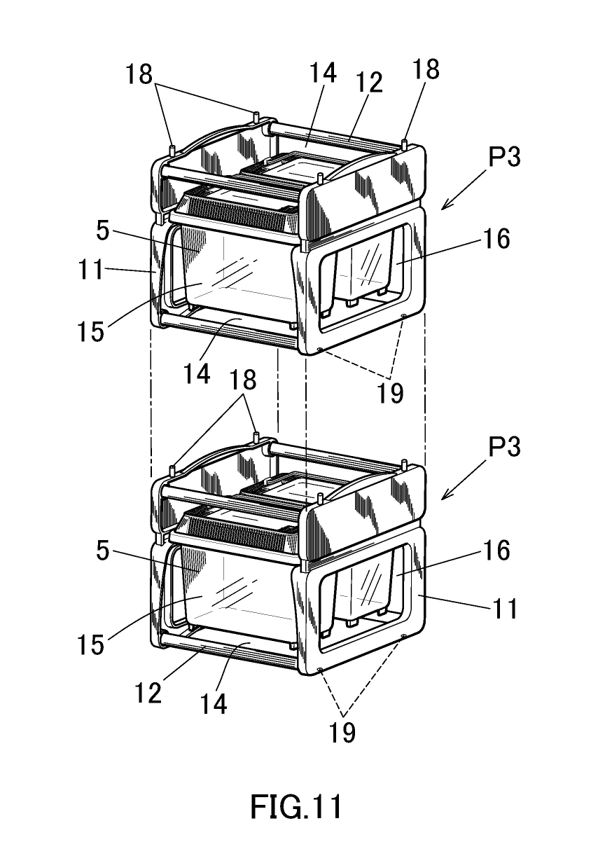

FIG. 11 is a perspective view for explaining a habitat container system P 3 according to a third embodiment of the present invention. As shown in the figure, only one container installation space 13 is provided in the holder 1 of the habitat container system P 3 of the third embodiment. Further, openings 14 to 16 are provided on both upper and lower side surfaces, right and left side surfaces, and front and rear side surfaces of the holder 1. Due to these openings 14 to 16, substantially the entire upper and lower surfaces, right and left side surfaces, and both front and rear surfaces of the container installation space 13 are opened in the up and down direction, the left and right direction, and the front and rear direction.

Further, at the upper ends of the pair of front and rear frames 11 of the holder 1, positioning convex portions 18 are formed, respectively. At the lower ends of the pair of front and rear frames 11 of the holder 1, corresponding to the positioning convex portions 18, positioning concave portions 19 are formed, respectively. In the present embodiment, the positioning convex portion 18 and the positioning hole 19 constitute a positioning member.

In this habitat container system P3 of the third embodiment, since the other configurations are substantially the same as those of the habitat container system P1 of the first embodiment, the identical or corresponding parts are denoted by the same reference numerals, and the redundant description is omitted.

In the third embodiment, only one habitat container system P3 can be used, but usually two or more habitat container systems P3 are used. That is, two or more habitat container systems P3 of this embodiment are used by stacking one on top of the other. In this stacked state, the upper positioning convex portions 18 of the lower habitat container system P3 among the habitat container systems P3 arranged vertically are fitted into the lower end positioning holes 19 of the upper habitat container system P3, so that the holders P3 and P3 arranged vertically adjacent are fixed to each other. This prevents habitat container systems P3 and P3 from being inadvertently disassembled.

Note that it is also possible to arrange a plurality of habitat container systems P3 of the third embodiment in the front and rear direction and in the left and right direction.

In the habitat container system P3 of the third embodiment, since the front and rear sides, the left and right sides, and the upper and lower sides of the holder 1 are opened, when viewing or observing animals, plants, etc., kept in the habitat container 5 of the holder 1, there are few members that obstruct observation, and thus it is possible to fully enjoy the observation. Even if a plurality of holders P3 are used in a vertically stacked manner, since partitions, such as, e.g., shelf boards, ceiling walls, and bottom walls, are not formed, it is possible to sufficiently enjoy observation of animals, plants, etc., kept in the habitat containers 5 without the visibility being blocked by partition walls, etc.

Further, in the habitat container system P3 of the third embodiment, not only one unit may be used, but also two or more units may be used in a stacked manner. Therefore, the number of stages of the container installation spaces 13 can be freely adjusted depending on the preference of a user and a breeding situation, such as, e.g., a breeding place, which can improve the versatility.

Here, the structure in which, for example, three habitat container systems P3 of the third embodiment are stacked corresponds to the structure of the habitat container system P1 of the first embodiment. On the contrary, the structure obtained by dividing the habitat container system P1 of the first embodiment between the container installation spaces 13 and 13 arranged vertically adjacent in the holder 1 corresponds to the habitat container system P3 of the third embodiment. That is, in the present invention, as in the first embodiment, the habitat container system P1 in which a plurality of container installation spaces 13 are arranged vertically may be configured to be dividable between the container installation spaces 13 and 13 arranged vertically adjacent in the holder 1.

In the habitat container systems P1 to P3 of the aforementioned three embodiments, the container installation space 13 is provided in one or three stages in the holder 1. However, the present invention is not limited thereto. In the present invention, two or four or more container installation spaces may be provided in the holder 1.

In the aforementioned embodiments, the case in which one or two habitat containers 5 are provided for one container installation space 13 was described as an example, but not limited. In the present invention, three or more habitat containers 5 may be provided for one container installation space.

Further, in the third embodiment, the positioning convex portions 18 are formed at the upper end of the holder 1 and the positioning concave portions 19 are formed at the lower end of the holder 1 as positioning members, but not limited to that. In the present invention, a positioning concave portion may be formed at the upper end of the holder 1 and a positioning convex portion may be formed at the lower end of the holder 1. Furthermore, in the present invention, the positioning members are not limited to the positioning convex portion 18 and the positioning concave portion 19, but other positioning members may be used. For example, it may be configured such that positioning grooves are formed in the upper end portion of the holder 1 and that the lower edge of the frame of the upper side habitat container system or the lower end portion of the holder such as the connecting pipe are fitted in the positioning groove of the holder in the lower habitat container system to thereby position the habitat container systems arranged vertically adjacent. It goes without saying that it may be configured such that a positioning groove is formed at the lower end of the holder and the upper end of the holder of the lower habitat container system is fitted in the positioning groove of the holder in the upper habitat container system.

It should be noted that, in the present invention, when referring to a plastic habitat container, it is sufficient that at least the container body of the habitat container is made of plastic, and the lid does not necessarily need to be made of plastic, and the lid may be made of other materials, such as, e.g., metal and wood.

The habitat container system of the present invention can be used for displaying and storing habitat containers keeping relatively small animals, plants, etc.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### DESCRIPTION OF REFERENCE SYMBOLS

1: holder
11: frame
13: container installation space
14: vertical opening
15: lateral opening
16: front and rear openings
2: rail (support portion)
21: cutout portion (positioning concave portion)
5: habitat container
6: container body
61: bottom wall
62: peripheral wall
63: upper end opening
64: opening edge portion
65: front and rear side portions (outward protrusion)
7: lid
72: hook
73: bent portion (Positioning convex portion)
P1 to P3: habitat container system

1. A habitat container system comprising:
at least one habitat container made of plastic; and
a holder provided with plural container installation spaces each capable of accommodating the habitat container, the plural installation spaces being arranged vertically,
wherein the holder includes
a pair of front and rear frames arranged forward and rearward of the container installation space,
a lateral opening that laterally opens the container installation space,
a vertical opening that communicates the container installation spaces arranged vertically adjacent, and
a pair of front and rear support portions provided on opposing sides of the pair of front and rear frames in each container installation space,
wherein the habitat container includes a pair of outward protrusions outwardly protruded from front and rear sides of the habitat container,
wherein the habitat container is capable of being freely taken in and out of the container installation space via the lateral opening, and
wherein in a state in which the habitat container is accommodated in the container installation space, the pair of outward protrusions of the habitat container are arranged on the pair of front and rear support portions of the holder and the habitat container is supported by the holder.

2. The habitat container system as recited in claim 1,
wherein the pair of front and rear frames is provided with front and rear openings that open each of the container installation space in a front and rear direction.

3. The habitat container system as recited in claim 1,
wherein the pair of front and rear support portions of the holder is configured by a pair of rails extending in a lateral direction, and
wherein the at least one habitat container is plural habitat containers, and at least two of the plural habitat containers are arranged side by side in one of the plural container installation spaces in the lateral direction.

4. The habitat container system as recited in claim 1,
wherein the pair of outward protrusions of the habitat container is provided with one of a positioning convex portion and a positioning concave portion, and the pair of front and rear support portion of the holder is provided with the other of the positioning convex portion and the positioning concave portion, and
wherein the positioning convex portion is fitted in the positioning concave portion to thereby position the habitat container relative to the holder.

5. The habitat container system as recited in claim 1,
wherein the habitat container includes a container body, the container body including
a bottom wall,
a peripheral wall provided at an outer peripheral edge portion of the bottom wall so as to extend upward,
an upper end opening provided on an inner side of an upper end of the peripheral wall, and
an opening edge portion outwardly protruded from an upper edge of the the peripheral wall along a circumferential direction, and
wherein the pair of outward protrusions is configured by front and rear side portions of the opening edge portion.

6. The habitat container system as recited in claim 4, wherein
the habitat container includes a container body and a lid,
the container body includes a bottom wall, a peripheral wall provided at an outer peripheral edge portion of the bottom wall so as to extend upward, an upper end opening provided on an inner side of an upper end of the peripheral wall, and an opening edge portion outwardly protruded from the upper edge of the a peripheral wall along a circumferential direction,
the lid includes a pair of front and rear hooks formed at front and rear sides of the lid,
the pair of front and rear hooks is elastically engaged with front and rear side portions of the opening edge portion, so that the lid is fixed to the container body in a state of closing the upper end opening of the container body,
the pair of outward protrusions is configured by the front and rear side portions of the opening edge portion, and
the positioning convex portion is configured by a tip portion of the hook.

7. The habitat container system as recited in claim 1, wherein the holder is configured to be divided between the plural container installation spaces arranged vertically adjacent.

8. A habitat container system comprising:
a habitat container made of plastic; and
a holder provided with a container installation space capable of accommodating the habitat container,
wherein the holder includes
a pair of front and rear frames arranged forward and rearward of the container installation space,
a lateral opening that opens the container installation space laterally,
a vertical opening that opens the container installation space vertically, and
a pair of front and rear support portions provided on opposing sides of the pair of front and rear frames,
wherein the habitat container is provided with a pair of outward protrusions formed at front and rear sides of the habitat container,
wherein the habitat container is capable of being freely taken in and out of the container installation space via the lateral opening, and
wherein in a state in which the habitat container is accommodated in the container installation space, the pair of outward protrusions of the habitat container is arranged on the pair of front and rear support portions of the holder and the habitat container is supported by the holder.

9. The habitat container system as recited in claim 8,
wherein the pair of front and rear frames is provided with front and rear openings that open the container installation space in the front and rear direction.

10. The habitat container system as recited in claim 8,
wherein one of a positioning convex portion and a positioning concave portion is formed at an upper end of the holder and the other of the positioning convex portion and the positioning concave portion is formed at a lower end of the holder.

11. A habitat container display structure comprising:
a plurality of the habitat container systems as recited in claim 1,
wherein the plurality of the habitat container systems is arranged in contact with each other.

12. The habitat container display structure as recited in claim 11,
wherein the plurality of the habitat container systems is stacked vertically.

13. The habitat container display structure as recited in claim 11,
wherein the plurality of the habitat container systems is arranged side by side horizontally.
